(19) United States
(12) Patent Application Publication
(10) Pub. No.: US 2023/0246927 A1
(43) Pub. Date: Aug. 3, 2023

(54) CROSS-NETWORK PERFORMANCE TESTING FOR AN APPLICATION AND CORRELATION OF RESULTS FOR ENHANCED PERFORMANCE ANALYSIS

(71) Applicant: Palo Alto Networks, Inc., Santa Clara, CA (US)

(72) Inventors: Hristos Siakou, Mountain View, CA (US); John Edward Bothe, Mount Eliza (AU)

(21) Appl. No.: 17/649,202

(22) Filed: Jan. 28, 2022

(51) Int. Cl. H04L 41/5009; H04L 41/046; H04L 43/0852; H04L 43/0829

(52) U.S. Cl. CPC H04L 41/5009; H04L 41/046; H04L 43/0852; H04L 43/0829

(57) ABSTRACT

Performance tests targeting an application executing on a destination server and the network elements along the path thereto are executed by agents installed on multiple types of respective hosts across geographic locations. Agents execute incremental performance tests to identify network elements on the path and values of metrics indicative of network element delay and submit requests for accessing resources and/or invoke an API of the application to determine delay associated with accessing the application. The agents associate descriptive metadata with the test results before a central system obtains the test results and associated metadata for analysis to determine whether measured delay recorded in the results is indicative of a performance issue. If a performance issue is identified in a set of the results, the related metadata are evaluated to determine correlations between the results that provide further insight into the performance issue and affected end users of the application.

### BACKGROUND

The disclosure generally relates to transmission of digital information and to arrangements for monitoring or testing packet switching networks.

As an increasing number of applications have transitioned from being hosted on-premises to the cloud under the software as a service (SaaS) model and wireless mobile networks have become more widely available (e.g., 4G/5G networks), the scope of network elements and infrastructure involved in application delivery has expanded. For instance, network elements offered by a plurality of Internet service providers (ISPs) and cloud service providers (CSPs) across geographic locations can be traversed along routes between users of an application and the remotely located server on which the application is hosted. While the prevalence in SaaS applications and mobile network coverage have improved application availability, troubleshooting performance issues in application delivery can present a challenge due to the wide distribution of network elements and infrastructure.

Network path traces are one technique for network diagnostics operations to determine the source of delays in packet delivery along such routes. Network path tracing techniques are implemented to trace the path taken by a packet from its source to its destination to allow for identification of intermediate network elements (e.g., routers). The traceroute and tracert commands are commonly executed to trace a network path of a Transmission Control Protocol (TCP) or User Datagram Protocol (UDP) packet from a source device to a target Internet Protocol (IP) address or hostname. The implementation of TCP traceroute, for example, sends a series of TCP packets targeting the destination address with an incrementing time to live (TTL) value such that latencies of each hop can be measured until the destination address is reached. Results of tracing a network path such as with traceroute/tracert indicate the route of a packet in terms of IP addresses of each of the network elements, also referred to as “nodes,” traversed along the path to the destination as well as the time taken by the packet to complete each hop between nodes.

### BRIEF DESCRIPTION OF THE DRAWINGS

Aspects of the disclosure may be better understood by referencing the accompanying drawings.

FIG. 1 depicts a conceptual diagram of providing improved visibility into network infrastructure and performance through collection and correlation of cross-agent performance test results.

FIG. 2 is a conceptual diagram of testing performance of an application and network elements traversed by network traffic of the application.

FIGS. 3A-3B are flowcharts of example operations for testing delay associated with accessing a target application.

FIG. 4 is a conceptual diagram of correlation of cross-agent performance test results for identification of performance issues.

FIG. 5 is a flowchart of example operations for obtaining and processing cross-agent performance testing results.

FIG. 6 is a flowchart of example operations for identifying performance issues based on correlation of cross-agent performance test results.

FIG. 7 depicts an example computer system with a correlation and analysis system and a performance testing agent.

### DESCRIPTION

The description that follows includes example systems, methods, techniques, and program flows that embody aspects of the disclosure. However, it is understood that this disclosure may be practiced without these specific details. For instance, this disclosure refers to sending TCP SYN packets as part of determining node IP addresses and their latencies in illustrative examples. Aspects of this disclosure can be instead applied to other packet types that include a TTL field, such as UDP or Internet Control Message Protocol (ICMP) echo request packets. In other instances, well-known instruction instances, protocols, structures and techniques have not been shown in detail in order not to obfuscate the description.

### Terminology

This description uses shorthand terms related to cloud technology for efficiency and ease of explanation. When referring to “a cloud,” this description is referring to the resources of a CSP. For instance, a cloud can encompass the servers, virtual machines, and storage devices of a CSP. In more general terms, a CSP resource accessible to customers is a resource owned/manage by the CSP entity that is accessible via network connections. Often, the access is in accordance with an application programming interface or software development kit provided by the CSP. When referring to “a cloud instance,” this description is referring to a virtual server instance or virtual machine offered by the CSP.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

### Overview

Conventional network path tracing and analysis techniques can provide an estimate of delays in packet delivery. However, these techniques may not provide high confidence in identifying the network element(s) that is responsible for performance issues impacting end users of an application. Additionally, the variations in network element performance across paths and across sessions that are inherent to network communications introduces challenges in distinguishing true performance issues from outliers. This arises from the lack of data collected from network element performance tests executed for multiple paths having disparate sources and instead relying on data obtained for a same source-destination pair. Potential performance issues that are identified thus are often identified with low confidence. Further, diagnosis of performance issues that affect SaaS applications executing on public cloud infrastructure can be difficult, as the application owners do not own the infrastructure supporting the application deployment and thus lack visibility into issues that may be contributing to diminished performance.

Described herein are techniques that increase the confidence in identifying network elements that are exhibiting diminished performance to which performance issues of an application are attributable. The described techniques also allow network issues to be distinguished from application issues to facilitate targeted remediation on the correct source of the performance issue. Performance tests targeting both an application executing on a destination server (e.g., a SaaS application) and the network elements along the path to the destination server are executed by agents installed on a multitude of hosts across geographic locations, such as endpoint devices, public cloud infrastructure, and/or wireless cellular network infrastructure. Results of the tests thus originate from a diverse array of sources rather than a single source. For testing network elements along a path to a destination server, each agent determines a latency of the path as a whole and subsequently executes incremental performance tests for determination of the network elements on the path as well as values of metrics indicative of delay (e.g., latency, jitter, and/or packet loss). For testing the application, each agent can submit one or more requests for accessing resources (e.g., webpages) and/or invoke application functionality exposed via an application programming interface (API) of the application and determine the associated delay for fulfillment of the requests. Results of the tests indicate IP addresses of nodes on the path and their associated delay metric values as well as delay accumulated from accessing application functionality.

The agents associate various metadata with the test results that are descriptive thereof and by which test results may be correlated. Examples of metadata that may be associated with test results generated by an agent include geographic location of the testing source to which the agent is deployed, geographic location of the target application/server, and ISP that services the testing source. A central system obtains the test results and associated metadata across deployed agents and can attach additional metadata to the incoming test results for further description of the results. As results are obtained, the system analyzes recorded delay for the target application(s) to determine whether changes in delay metric values may be indicative of a performance issue. If a performance issue is identified based on a set of test results, the system can evaluate the metadata associated with results in the set to determine how the results are correlated based on having metadata in common. Correlation of the tests results provides further insight into the performance issue and the end users of the application that may be affected by the performance issue, such as based on whether the performance issue is attributable to a network element associated with a certain ISP or is impacting end users in a geographic area. Performance issues and the entity to which they are attributable can thus be identified with an increased degree of confidence based on correlation of results that span networks and were collected from a variety of sources.

### Example Illustrations

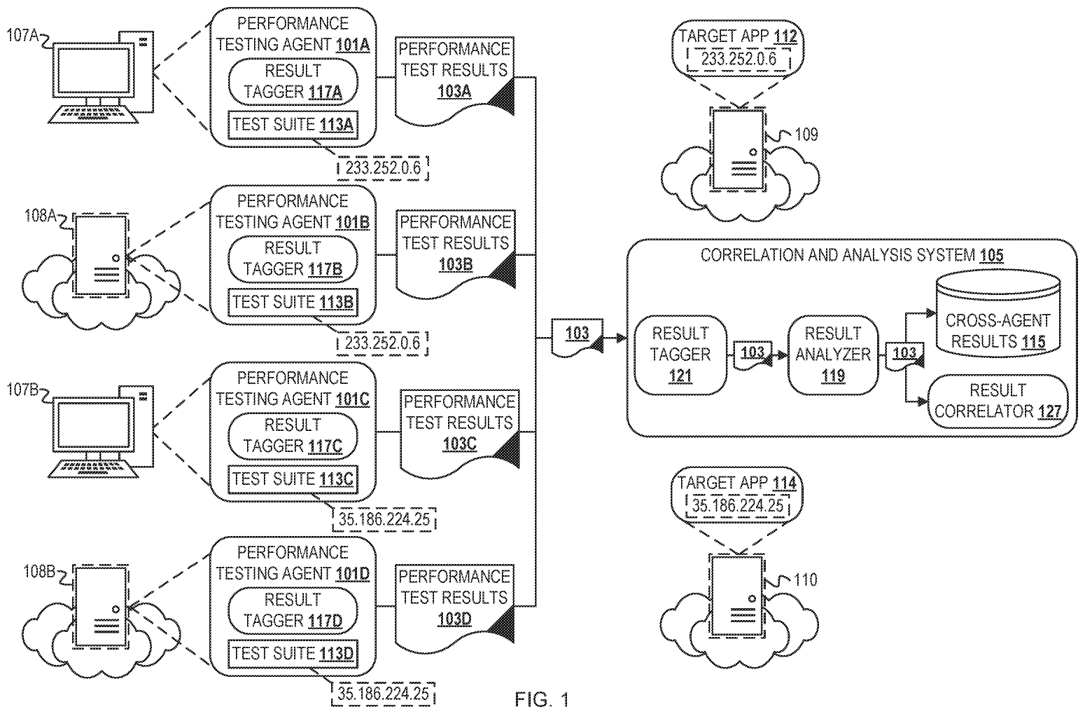

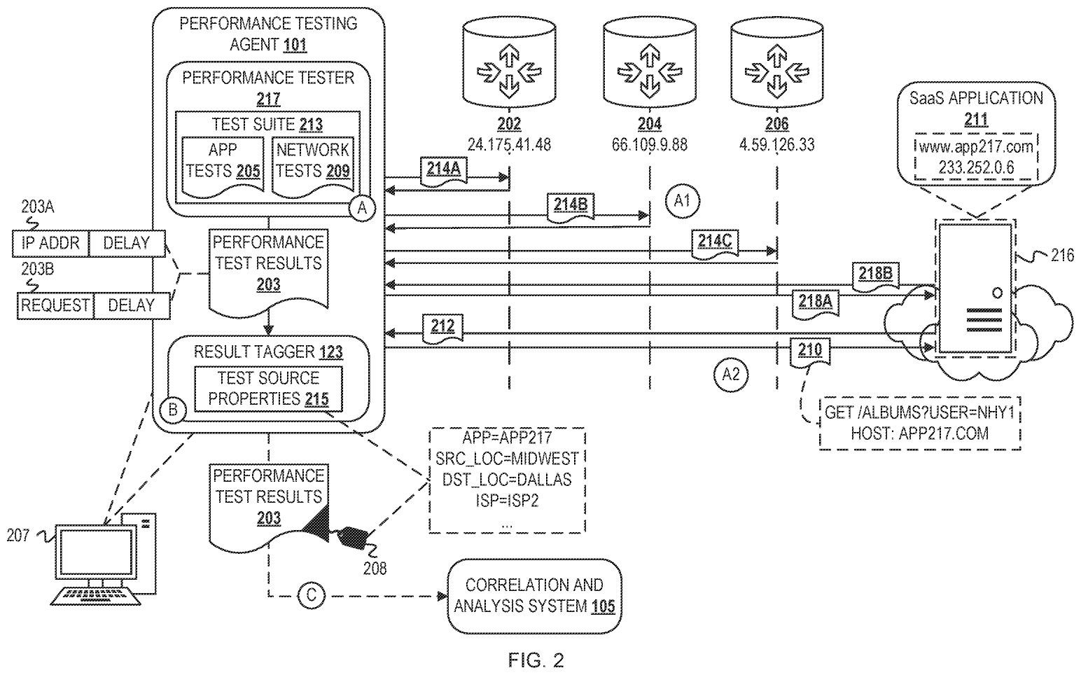

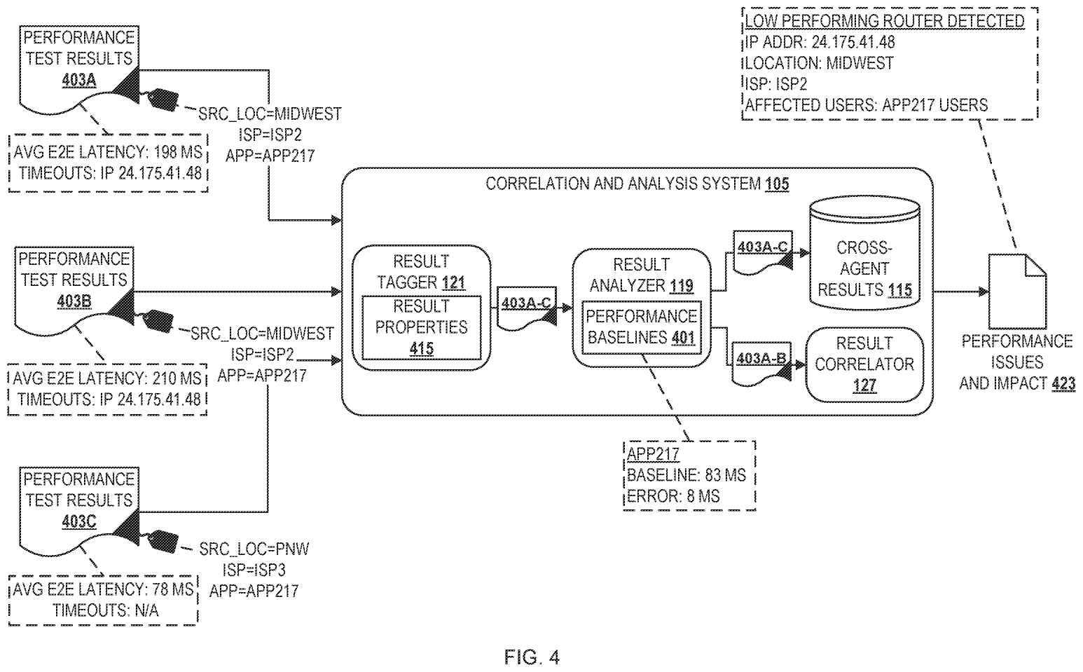

FIG. 1 depicts a conceptual diagram of providing improved visibility into network infrastructure and performance through collection and correlation of cross-agent performance test results. Performance testing agents (“agents”) 101A-D have been deployed to respective testing sources. A testing source refers to a source from which performance tests targeting applications and/or network elements originate. In this example, the testing sources include endpoint devices 107A-B and cloud instances 108A-B, though testing sources can include any devices or hardware elements to which agents can be deployed for execution thereon. The agents 101A-D communicate with a correlation and analysis system (“system”) 105. The system 105 manages central collection and analysis of results of the performance tests executed by the agents 101A-D deployed across testing sources. In this example, operations of the agents 101A-D for testing performance of their respective targets and operations of the system 105 for analyzing cross-agent performance test results are described at a high level. Execution of performance tests and processing of results by the agents 101A-D are described in further detail in reference to FIG. 2. Correlation and analysis of results collected across agents by the system 105 are described in further detail in reference to FIG. 4.

FIG. 1 depicts a target application 112 hosted on a cloud instance 109 and a target application 114 hosted on a cloud instance 110. The target application 112 is a SaaS application to which tests performed by the agents 101A, 101B deployed to the endpoint device 107A and the cloud instance 108A, respectively, are directed. The target application 114 is a SaaS application to which tests performed by the agents 101C, 101D deployed to the endpoint device 107B and the cloud instance 108B, respectively, are directed. Performance tests executed by the agents 101A-B that are directed to the target application 112 test performance of the target application 112 and/or performance of network elements on respective paths from the endpoint device 107A and cloud instance 108A to the destination IP address associated with the target application 112 (233.252.0.6 in this example). Performance tests executed by the agents 101C-D that are directed to the target application 114 test performance of the target application 114 and/or performance of network elements on respective paths from the endpoint device 107B and cloud instance 108B to the destination IP address associated with the target application 114 (35.186.224.25 in this example).

Performance tests to be executed by each of the agents 101A-D are indicated in a respective one of a plurality of test suites 113A-D attached to (i.e., installed on or otherwise made accessible to) the corresponding agent. The test suites 113A-D indicate one or more performance tests that target a corresponding one of the target applications 112, 114 to test performance of the target application and/or the network elements on a path from the testing source to the destination given by the IP address of the target application. Tests indicated in each of the test suites 113A-D that test performance of network elements of the path to the IP address of the corresponding one of the target applications 112, 114 may include tests for identifying the network elements on the path and determining values of metrics indicative of delay for each network element (e.g., through execution of TCP traceroute or a similar test) as well as an end-to-end delay of the path. Tests indicated in each of the test suites 113A-D that test performance of the respective one of the target applications 112, 114 may include a resource(s) of the target application to request (e.g., resources identified by a uniform resource locator (URL)) and/or application functionality exposed by an API of the target application to invoke for which associated metrics indicative of delay should be determined. Results 103A-D of performance testing generated by the agents 101A-D based on execution of tests specified in each of the test suites 113A-D thus comprise indications of delay associated with each network element involved in communications between the respective testing source and the target application as well as indications of performance of the respective target application.

The result taggers 117A-D associate metadata with corresponding ones of the results 103A-D. The result taggers 117A-D maintain various properties of the corresponding one of the agents 101A-D, the corresponding testing source, the target application, or any combination thereof. The properties maintained by each of the result taggers 117A-D are added to the respective ones of the results 103A-D as metadata and describe characteristics of the test results, testing source, and/or target application. For instance, the result tagger 117A can maintain properties indicating a geographic location of the endpoint device 107A, an ISP servicing the endpoint device, etc. and associate these properties with the results 103A as metadata. Metadata associated with the results 103A-D provide context of the results 103A-D which facilitate analysis thereof.

The system 105 obtains the results 103A-D with which the corresponding metadata have been associated. A result tagger 121 of the system 105 may associate additional metadata with one or more of the results 103A-D based on additional properties of the testing sources and/or target applications that it maintains. A result analyzer 119 of the system 105 analyzes the results 103A-D to determine whether any of the results 103A-D are indicative of a performance issue of the target application 112, target application 114, and/or a network element(s) of the path to the destination IP address associated with either of the target applications 112, 114. The result analyzer 119 inserts the results 103A-D into a repository 115 of cross-agent results. If any of the results 103A-D are indicative of a performance issue, the results analyzer 119 passes the identified results to a result correlator 127 for further analysis and correlation to determine characteristics that the identified results have in common based on the metadata associated therewith. Metadata in common among results indicative of diminished performance provide information about sources to which the diminished performance is attributable and indicate impact of the diminished performance. For instance, metadata in common among the results indicative of diminished performance may characterize end users of the target application 112 and/or target application 114 that are impacted by the diminished performance. Diagnostics and remediation can thus target the entity(ies) to which poor user experience characterized by the metadata is attributable.

FIG. 2 is a conceptual diagram of testing performance of an application and network elements traversed by network traffic of the application. FIG. 2 depicts one of the agents 101A-D of FIG. 1 in additional detail, depicted as performance testing agent (“agent”) 101. The agent 101 has been deployed to a testing source 207 as described in reference to FIG. 1. While the testing source 207 is depicted as an endpoint device in this example, in implementations, the testing source can be a cloud infrastructure element or other element/device that supports agent deployments (e.g., a 4G/5G network infrastructure element). The agent 101 tests performance of an application 211 that is a SaaS application hosted on a cloud instance 216 and performance of network elements 202, 204, 206 traversed by network traffic of the application 211 that originates from the testing source on which the agent 101 executes. The scenario is an example of performance tests executed by one agent for a SaaS application. In implementations, agents can be deployed to a plurality of testing sources for execution of performance tests directed to an application(s) such as the SaaS application and the network elements on the path(s) to the destination IP address(es) of the application(s). Thus, the network elements along the path to the application destination IP address for which performance is tested can vary across deployed agents.

FIG. 2 is annotated with a series of letters A-C. These letters represent stages of operations. Additionally, stage A is described as including two sub-stages, stage A1 and stage A2. Although these stages are ordered for this example, the stages illustrate one example to aid in understanding this disclosure and should not be used to limit the claims. Subject matter falling within the scope of the claims can vary with respect to the order and some of the operations.

At stage A, a performance tester 217 of the agent 101 performs a series of tests of a test suite 213 targeting the application 211. The test suite 213 comprises application tests 205 and network tests 209. The application tests 205 comprise tests for determining performance of the application 211. The network tests 209 comprise tests for determining an end-to-end latency of the path to the IP address of the application 211 and delay of network elements along the path. Testing pertaining to the network path trace and network elements that is indicated by the network tests 209 is described in reference to stage A1. Testing of the application 211 that is indicated by the application tests 205 is described in reference to stage A2. While depicted and described as separate stages, the stages A1 and A2 may be performed at least partially in parallel or concurrently.

At stage A1, the performance tester 217 executes the network tests 209 to test end-to-end delay and delay per network element for the path between the testing source 207 and the IP address of the application 211, depicted as 233.252.0.6 in this example. The network tests 209 may be represented as a plurality of scripts that may be parameterized. A first of the network tests 209 is a test to determine an end-to-end latency of the path from the testing source 207 to the IP address of the application 211 based on sending a packet 218A having a destination IP address of 233.252.0.6 to target the application 211 and determining a time between sending the packet 218 and receiving a response 218B that indicates the application 211 IP address as the source IP address. The packet 218A may comprise a TCP SYN (synchronize) packet, and the response 218B may comprise a TCP SYN-ACK (acknowledgement) packet.

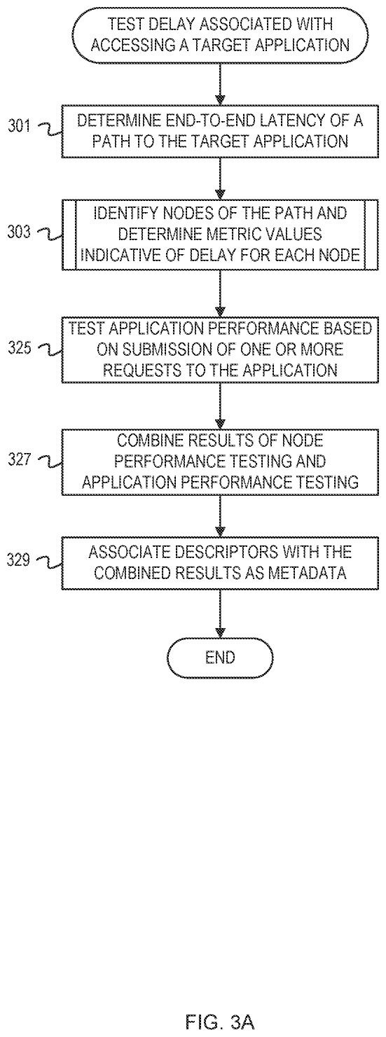

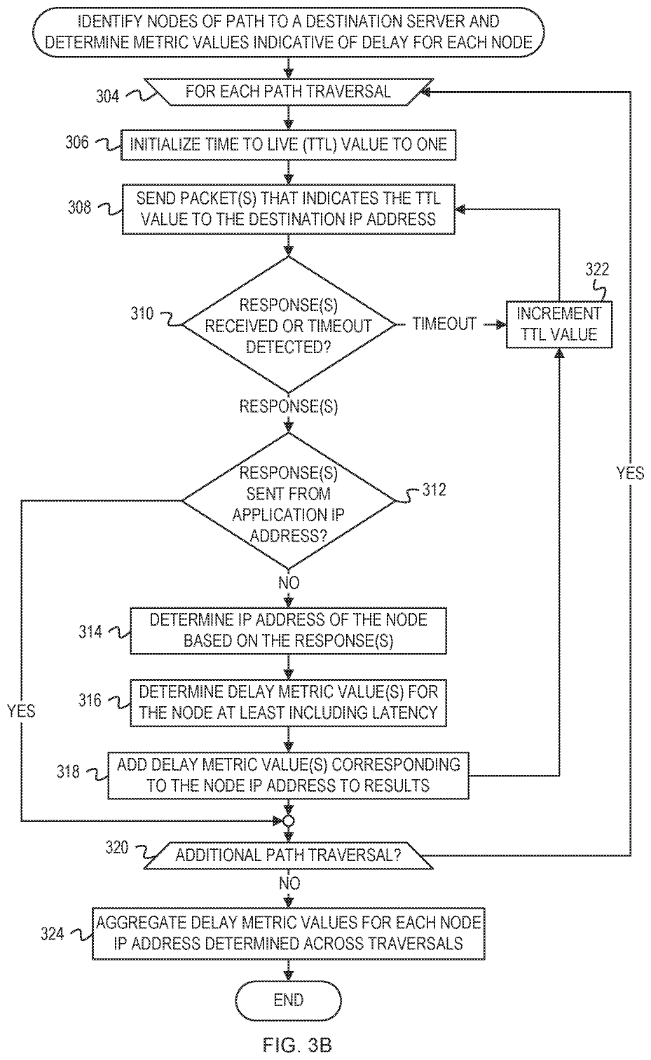

The performance tester 217 then performs subsequent ones of the network tests 209 for incremental testing of network elements on the path to determine IP addresses and delay metric values of each network element, which includes the network elements 202, 204, 206 in this example. To perform the incremental tests, the performance tester 217 incrementally sends packets 214A-C that target a corresponding one of the network elements 202, 204, 206. The packets 214A-C can be TCP SYN packets that include a TTL value in the TTL field that corresponds to a hop count of the network element being targeted (i.e., TTL=1 to target the network element 202, TTL=2 to target the network element 204, etc.). The performance tester 217 initializes the TTL value to one and increments the TTL value after receipt of each response from the targeted network element. The responses may be Internet Control Message Protocol (ICMP) time exceeded messages. Latencies of each network element 202, 204, 206 can thus be determined based on the times between sending each of the TCP SYN packets and receiving the corresponding ICMP time exceeded message. The performance tester 217 may determine additional delay metric values for each network element, such as packet loss and/or jitter, by sending multiple TCP SYN packets that target the network element and determining standard deviation of the corresponding latencies and/or determining a count of packets send relative to packets received for determining jitter and packet loss, respectively. Incremental testing of network elements for determination of delay metric values is described in further detail in reference to FIG. 3B.

To increase confidence in the results of the network tests 209, the performance tester 217 may traverse the path between the testing source 207 and the application 211 IP address multiple times for execution of the network tests 209 and aggregate the delay metric values determined across traversals. As an example, the performance tester 217 may complete five traversals of the path and corresponding executions of the network tests 209 such that five sets of delay metric values are obtained for each of the network elements 202, 204, 206 (e.g., five latencies for each network element). The delay metric values determined for each network element can then be aggregated to at least determine an average latency for each network element. The performance tester 217 can also determine jitter and packet loss for each node based on the average latencies and a count of responses received relative to packets transmitted for each node across traversals, respectively. The performance tester 217 creates results 203A that indicate the end-to-end latency of the path, IP addresses of the intermediate network elements along the path (i.e., the network elements 202, 204, 206), and delay metric values determined for each of the intermediate network elements.

At stage A2, the performance tester 217 executes the application tests 205 to test performance of the application 211. The application tests 205 may be represented as one or more valid requests for resources of the application 211 and/or one or more valid functions of an API of the application 211 to invoke for which the associated delay is to be measured. In this example, the performance tester 217 sends a request 210 (e.g., a Hypertext Transfer Protocol (HTTP)/HTTP Secure (HTTPS) request according to a type of server that the cloud instance 216 is configured as) for a resource of the application 211 identified by the URL “www.app217.com/albums?user=NHY1”. The performance analyzer 217 obtains a response 212 from the cloud instance 216 that indicates whether the request 210 was successfully fulfilled. The performance tester 217 can then determine a latency associated with retrieval of the resource of the application 211 indicated in the request 210 based on times between sending the request 210 and receiving the response 212. The performance tester 217 creates results 203B that indicate delay associated with fulfillment of the request or invocation of application functionality indicated by the tests. The performance tester 217 combines the results 203A and results 203B to generate results 203 of performance testing. Results indicative of network element performance can thus be distinguished from those indicative of application performance during subsequent analysis of the results.

At stage B, the result tagger 123 tags the results 203 with metadata based at least partly on properties 215 associated with the testing source 207 on which the agent 101 executes. The properties 215 may be stored in a data structure maintained by the result tagger 123, in a configuration file installed on the agent 101/result tagger 123, etc. The properties 215 can include properties of the originating source of the results 203 (e.g., properties associated with the testing source 207), properties of the application 211 indicated by the test suite 213, or a combination thereof. Examples of properties include technology type used by the testing source for accessing the application 211 (e.g., 4G/5G, fiber, etc.), ISP that services the testing source, geographic location (e.g., region) of the testing source, geographic location of the server hosting the application for which testing is being performed, identity of the application for which testing is being performed, or any combination thereof. In this example, the properties 215 identify the application associated with the tests as “app217” and indicate that the testing source is located in the Midwest region, the destination location is located in Dallas, and the ISP of the testing source is an ISP referenced as “ISP2.” The results tagger 123 tags the results 203 with the properties 215, which associates the properties 215 with the results 203 as metadata 208.

At stage C, the agent 101 communicates the results 203 and the associated metadata 208 to the system 105. The system 105 may periodically poll agents deployed across test sources for new test results (e.g., according to a schedule for result collection enforced for the system 105). In this case, collecting the results 203 includes the system 105 retrieving the results 203 from the agent 101. As another example, the agent 101 may periodically communicate results to the system 105, such as according to a schedule for reporting results enforced for deployed agents. For instance, the agent 101 may have been configured to report results to the system 105 every 15 minutes, 30 minutes, etc.

FIGS. 3A-3B are flowcharts of example operations for testing delay associated with accessing a target application. The example operations are described with reference to a performance testing agent (hereinafter “the agent”) for consistency with the earlier figures. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary. The example operations begin at block 301 of FIG. 3A.

At block 301, the agent determines an end-to-end latency of a path to the target application. The path refers to the path from the testing source on which the agent executes to the IP address of the application. The agent can send at least a first TCP SYN packet to the destination IP address. The TCP SYN packet indicates an IP address of the target application on a particular port that may correspond to a communication protocol used by the target application (e.g., 80 or 443 for Hypertext Transfer Protocol (HTTP) and Hypertext Transfer Protocol Secure (HTTPS), respectively). The agent records a timestamp associated with the sending of the TCP SYN packet. If multiple TCP SYN packets are sent, the agent records the times associated with each packet. The agent may distinguish between times based on recording sequence numbers included in the TCP segment headers of the TCP SYN packets. The agent will receive a TCP SYN-ACK packet(s) corresponding to the TCP SYN packet and may record a timestamp associated with receipt of the response(s). The agent can then determine the end-to-end latency for the path based on the timestamps associated with sending and receiving the TCP SYN and TCP SYN-ACK packets (e.g., as half of the difference between the time associated with sending the TCP SYN packet and receiving the TCP SYN-ACK packet). If multiple TCP SYN and TCP SYN-ACK pairings were timed, the agent can determine the end-to-end latencies for each pair and average the latencies to determine a single end-to-end latency.

At block 303, the agent identifies nodes of the path and determines metric values indicative of delay for each node. Example operations for tracing a path to a destination IP address and determining values of metrics indicative of delay, or “delay metric values,” are described in reference to FIG. 3B, which begins at block 304.

At block 304, the agent begins determining delay metric values of nodes based on each of one or more path traversals. A path traversal refers to the completion of performance testing for each of the nodes along the path. The agent can perform multiple traversals of the path for performance testing to obtain a corresponding number of sets of delay metric values for each node traversed (e.g., five sets of delay metric values per node as a result of five traversals of the path). The number of path traversals may be a configurable setting of the agent.

At block 306, the agent initializes a TTL value to one. The TTL value corresponds to the hop count of the node along the path that is currently being targeted for determination of delay metric values. For example, the first node on the path (i.e., the first hop) will be targeted by testing performed when the TTL value is one.

At block 308, the agent sends at least one packet that includes the TTL value in the TTL field to the application IP address as the destination address. The packet is considered to target the node having the hop count corresponding to the TTL value since the packet will expire at the node receiving the packet when the TTL value of is equivalent to one. The packet(s) sent by the agent can be TCP SYN packets, or TCP segments having the SYN flag of the TCP segment header set to 1. The TCP SYN packet(s) can target the destination IP address on a port according to a protocol used by the application or another port on which the server hosting the application listens for incoming connections corresponding to the application.

At block 310, the agent determines if a response(s) is received or if a timeout is detected. If the packet(s) expired in transit to the destination server due to the TTL value being equivalent to one upon receipt by an intermediate node (e.g., a router along the path), whether based on the TTL value being one at the time of packet sending or based on the TTL value being decremented by other intermediate nodes when the packet was in transit, the response can be an ICWIP time exceeded message that indicates an IP address of an intermediate node. Alternatively, the response can be a TCP SYN-ACK sent from the destination server if the packet reached the destination server without the TTL value being decremented to one in transit. A timeout may be detected if no response has been received within a timeout threshold established for performance testing. The timeout threshold may be a default value or may be a value that is based on previous results of performance testing. For instance, the timeout threshold may be a value(s) relative to the end-to-end latency and/or the maximum non-timeout latency determined for a prior node along the path. As an example, the timeout threshold may be represented as X % of the measured end-to-end latency for the first hop and Y % of the maximum latency of a prior node for subsequent hops (e.g., 75% of the end-to-end latency and 150% of the maximum latency of a prior node).

In some implementations, the timeout threshold relative to the end-to-end latency may be represented as a maximum of a fraction, percentage, etc. of the end-to-end latency and another value that is a configurable setting of or a parameter value provided to the agent, such as the maximum of 75% of the end-to-end latency and X, where X is any value in milliseconds (e.g., 100 milliseconds). Alternatively, or in addition, the timeout threshold relative to the maximum latency for a prior node may be represented as a maximum of a fraction, percentage, etc. of the maximum latency and the end-to-end latency. As an example, the performance analyzer may be represented as the maximum of the end-to-end latency and 150% of the maximum latency determined for a prior node along the path. If a response(s) is received without detection of a timeout, operations continue at block 312. If a timeout is detected, operations continue at block 322, wherein the TTL value is incremented before a subsequent packet(s) indicating the incremented TTL value is sent. The agent may record an indication that the hop count corresponding to the TTL value resulted in a timeout.

At block 312, the agent determines if the response(s) was sent from the application IP address. Responses sent from the application IP address will generally be TCP SYN-ACK packets that acknowledge the TCP SYN packets and indicate the application IP address as the sender. Each of the responses should be of a same type if multiple TCP SYN packets were sent. Responses sent from intermediate nodes on the path will generally be ICMP time exceeded messages that indicate the IP address of the corresponding node as the sender. If the response(s) was not sent from the application IP address and thus was sent from an intermediate node, operations continue at block 314. If the response(s) was sent from the application IP address, operations continue at block 320.

At block 314, the agent determines the IP address of the node based on the response(s). Responses will indicate the IP address of the node as the source IP address in the IP header. At block 316, the agent determines one or more delay metric values for the node that at least include latency of the node. The agent determines the latency based on a difference between the times of sending the packet(s) at block 308 and receiving the response(s) at block 310. If multiple packets were sent and corresponding responses received, the agent can determine the latency for each packet-response pair and aggregate the latencies (e.g., by averaging the latencies) and use the aggregate latency as the determined latency of the node. If multiple packets were sent, the agent may also determine jitter and/or packet loss for the node in addition to the latency.

At block 318, the agent adds the delay metric value(s) corresponding to the node IP address to the results. The agent may create one or more data structures for storing node IP addresses and corresponding delay metric values. For instance, the agent can create a data structure for delay metric values recorded across traversals for each node, wherein the results include the data structure for each node and stored delay metric values across traversals.

At block 320, the agent determines if an additional traversal of the path should be performed for determination of additional delay metric values or if the designated number of traversals has been performed. If an additional traversal should be performed, operations continue at block 304. If the designated number of traversals has been performed, operations continue at block 324.

At block 324, the agent aggregates the delay metric values for each node IP address determined across traversals. Aggregating the values of delay metrics at least includes aggregating (e.g., averaging) the latencies recorded for each node across traversals. If any timeouts were recorded for the hop count corresponding to the node, such as based on the absence of a latency value or any of the latency values being flagged or otherwise indicated as timeouts, the agent can discard/omit the traversal(s) associated with the timeout(s) from the aggregate latency calculation. As an example, if the agent completed five traversals and collected four non-timeout latencies for a node, the average latency can be determined for the four non-timeout latencies and for a sample size of four. The agent can also determine jitter and/or packet loss across the total number of traversals as part of aggregating the delay metric values. Packet loss may be represented as a total fraction, ratio, etc. of packets which yielded a timeout rather than a non-timeout latency value with respect to total packets sent. Operations continue at block 325 of FIG. 3A.

At block 325, the agent tests application performance based on submission of one or more requests to the application. Application performance can be tested by requesting one or more resources of the application and/or requesting that certain functionality of the application be invoked and determining the associated delay in fulfillment of the request. The requests may thus serve to simulate behavior of a user invoking functionality of the application via a client (e.g., a web browser). For each of the requests to be made to the application, the agent communicates the request to the application and determines a latency associated with the request based on receipt of a response (e.g., by determining a difference between the time the request was sent and the response was received). The agent may perform a configurable number of repetitions of issuance of each request so that multiple latencies associated with each request can be determined, with the agent aggregating (e.g., averaging) the latencies determined for each request; in this case, the agent may further determine jitter and/or packet loss corresponding to each request. As delay corresponding to each request is determined, the agent adds an indication of the delay to the results. The agent may also determine whether the request was successfully fulfilled based on analysis of the response (e.g., based on determining a status code indicated in an HTTP response) and add an indication of such to the results along with the delay.

The agent may further evaluate the delay metric value(s) obtained for each request based on one or more thresholds, ranges, or other criteria as part of testing application performance. For instance, the agent may evaluate the delay metric values determined for the application and added to the results based on an upper threshold and lower threshold for each metric value type to be evaluated. Values that are below the lower threshold may be labeled as “low delay”, and values that exceed the upper threshold may be labeled as “high delay.” Values that are between the thresholds may be labeled as “acceptable delay.” The agent may further determine an aggregate score for the application based on the labeling of delay metric values. For instance, each of the labels may be associated with a score designated in scoring rules maintained by the agent; an example set of scores is a score of 1 for “low delay” values, 3 for “acceptable delay” values, and 5 for “high delay” values. The agent can thus compute the aggregate score for the application based on aggregating individual scores assigned to each label with which the delay metric value(s) determined for the application were labeled.

At block 327, the agent combines results of node performance testing and application performance testing. The combined results indicate the end-to-end latency of the path traversed by network traffic of the application, IP addresses and corresponding delay metric values of each node along the path, and indications of application performance in terms of latencies associated with invocations of application functionality determined as a result of the testing.

At block 329, the agent associates descriptors with the combined results as metadata. The agent maintains a plurality of descriptors (e.g., in a data structure or configuration file) that describe characteristics of the agent and/or tests run by the agent. Descriptors provide additional information about groups of end users and/or geographic regions that may be impacted by any identified performance issues. Examples of descriptors include a geographic location from which the results originated, a geographic location of the destination targeted by the tests, a type of technology used by the testing source to which the agent is deployed for accessing the target application (e.g., 4G/5G, fiber, etc.), the ISP servicing the testing source, or any combination thereof. The agent associates the descriptors with the combined results as metadata. For instance, the agent may associate the descriptors with the combined results through labeling, tagging, or otherwise attaching the descriptors to the results.

FIG. 4 is a conceptual diagram of correlation of cross-agent performance test results for identification of performance issues. FIG. 4 depicts the system 105 in additional detail. The system collects results 403A, 403B, 403C of performance testing from corresponding agents as described above. The results 403A-C thus correspond to different agents that may execute on different types of testing sources. For instance, the results 403A-B may originate from respective endpoint devices, while the results 403C may originate from public cloud infrastructure (e.g., a cloud instance). Each of the results 403A-C comprise delay metric values determined based on a combination of network testing, including an end-to-end test to determine latency of a path and testing targeting each network element along the path, and application testing. The results 403A-C also include the associated metadata which indicate descriptors of the corresponding results, such as characteristics of the corresponding testing source.

FIG. 4 depicts additional detail of the results 403A-C, which comprise delay metric values corresponding to an application “APP217,” as an illustrative example. The results 403A indicate an average end-to-end latency of 198 milliseconds and a timeout identified for a network element with IP address 24.175.41.48 determined from the testing. The results 403A comprise metadata indicating that the results originated from a testing source located in the Midwestern region that is serviced by an ISP referenced as “ISP2.” The results 403B indicate an average end-to-end latency of 210 milliseconds and a timeout identified for the network element with IP address 24.175.41.48 determined from the testing. The results 403B comprise metadata indicating that the results originated from a testing source located in the Midwestern region that is serviced by an ISP referenced as “ISP2.” The results 403C indicate an average end-to-end latency of 78 milliseconds determined from the testing and comprise metadata indicating that the results originated from a testing source located in the Pacific Northwestern region that is serviced by an ISP referenced as “ISP3.”

The result tagger 121 can associate additional metadata with any of the results 403A-C based on result properties 415 maintained centrally by the result tagger 121. The result properties 415 include additional properties that are to be associated with one or more obtained results as additional metadata, or in addition to the metadata which the agents associated with the results. Additional properties may include properties that are obtained from other internal and/or third party systems for storage in the system 105. For instance, the result properties 415 may indicate users and/or user groups to which deployed agents correspond (e.g., based on agent identifiers). If the result properties 415 indicate a user(s) and/or user group(s) known to correspond to an agent from which results are obtained, the result tagger 121 can associate metadata with the obtained results that indicate the user(s) and/or user group(s). The result properties 415 may be stored in a data structure maintained by the result tagger 121 or in a file(s) attached to the result tagger 121. Properties of the result properties 415 may be conditioned on certain metadata already being associated with obtained results so that the association of additional metadata is targeted towards certain subsets of obtained results based on the result tagger 121 analyzing result metadata as results are obtained. As an example, first properties of the result properties 415 may be associated with results obtained from testing sources in the Midwestern region. The result tagger 121 can associate these first properties with the results 403A-B based on identifying the metadata that denotes the source location of the results 403A-B as the Midwestern region.

The result analyzer 119 analyzes delay metric values of the results 403A-C based on performance baselines 401 to determine whether any of the results 403A-C are indicative of diminished performance of the corresponding application being tested. The performance baselines 401 may be based on historical performance data, such as average delay metric values determined for an application during a past collection period. As an example, the performance baselines 401 may indicate baseline latencies, jitter, and/or packet loss values that correspond to the average values corresponding to the application over the past five collection periods or past 15 minutes that may include multiple collection periods. Diminished performance may be attributable to application issues, network issues (e.g., performance issues exhibited by network elements), or a combination thereof. The source to which diminished performance is attributable can thus be determined with increased confidence due to the wealth of test results collected across testing sources that include delay metric values determined as a result of network testing and as a result of application testing as is described above.

In this example, the performance baselines 401 indicate a baseline latency of 83 milliseconds with an error threshold of 8 milliseconds for the application “APP217.”The performance baselines 401 indicate a baseline end-to-end latency as an illustrative example and to aid in understanding, and performance baselines may comprise baselines for different and/or additional delay metric types (e.g., a jitter baseline, a baseline(s) corresponding to a certain request(s) issued to the target application during testing, etc.) The result analyzer 119 analyzes the delay metric values of each of the results 403A-C based on the performance baselines 401 to identify those that exceed the baseline and thus are indicative of diminished performance. In this example, the results 403A and the results 403B indicate an average latency that deviates from the baseline by an amount greater than the allotted error for the application “APP217” specified in the performance baselines 401, while the results 403C include a latency that is within the latency baseline plus error. The result analyzer 119 designates the results 403A-B for further analysis to determine correlations among the results 403A-B by the result correlator 127, such as by passing a copy of the results 403A-B to the result correlator 127 as input. The result analyzer 119 also can insert data and metadata of the results 403A-C to the repository 115 to make the results 403A-C available for subsequent analysis based on submission of queries to the repository 115.

The result correlator 127 analyzes metadata of the results 403A-B to determine metadata in common between the results 403A-B. In this example, the result correlator 127 identifies that the results 403A-B both correspond to the Midwestern region and the ISP “ISP2” based on the metadata in common. The result correlator 127 also determines that the subsets of the results 403A-B that indicate IP addresses of intermediate network elements both comprise the IP address 24.175.41.48 and an indication that the network element timed out. The network element with this IP address is thus a hop in common between the paths corresponding to both of the results 403A-B that timed out during both testing instances. These commonalities between the results 403A-B can be determined based on the result correlator 127 determining the intersection of metadata associated with both of the results 403A-B as well as the intersection of IP addresses of intermediate network elements indicated in the results 403A-B. The intersection of the intermediate network element IP addresses may account for each IP address to determine any hop in common among paths or may account for IP addresses of network elements associated with delay metric values that do not satisfy network element performance criteria. For instance, the result correlator 127 may determine the intersection of intermediate network element IP addresses for which a timeout was detected during network element testing.

The system 105 indicates a report 423 that indicates performance issues and their impact based on correlations identified by the result correlator 127. Indicating the report 423 can include storing the report 423 for subsequent access/reference, providing the report 423 to be displayed (e.g., on a user interface), or otherwise making the report 423 available. The report 423 indicates the correlations between the results 403A-B identified by the result correlator 127 based on metadata in common between the results 403A-B. The correlations reflect impact of the performance issues, such as in terms of affected end users of the application. In this example, the report 423 indicates that a low-performing router with IP address 24.175.41.48 associated with the ISP “ISP2” was detected and impacts users of the application “APP217” located in the Midwestern region. The impact of the performance issues identified for the application “APP217” thus impact users in the Midwestern region that are serviced by the ISP “ISP2.” Remediation and corrective action can thus be tailored based on the impact of the performance issue indicated by the report 423.

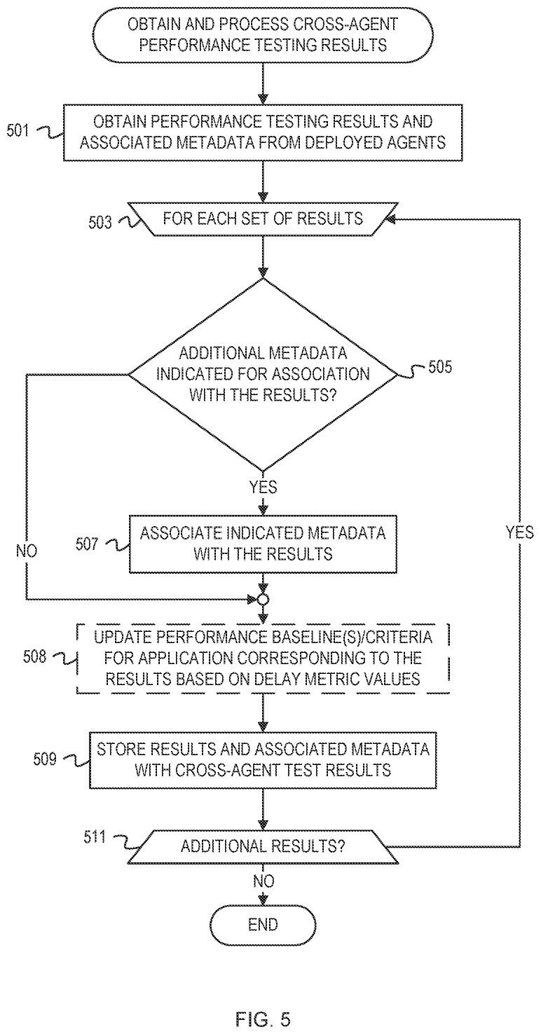

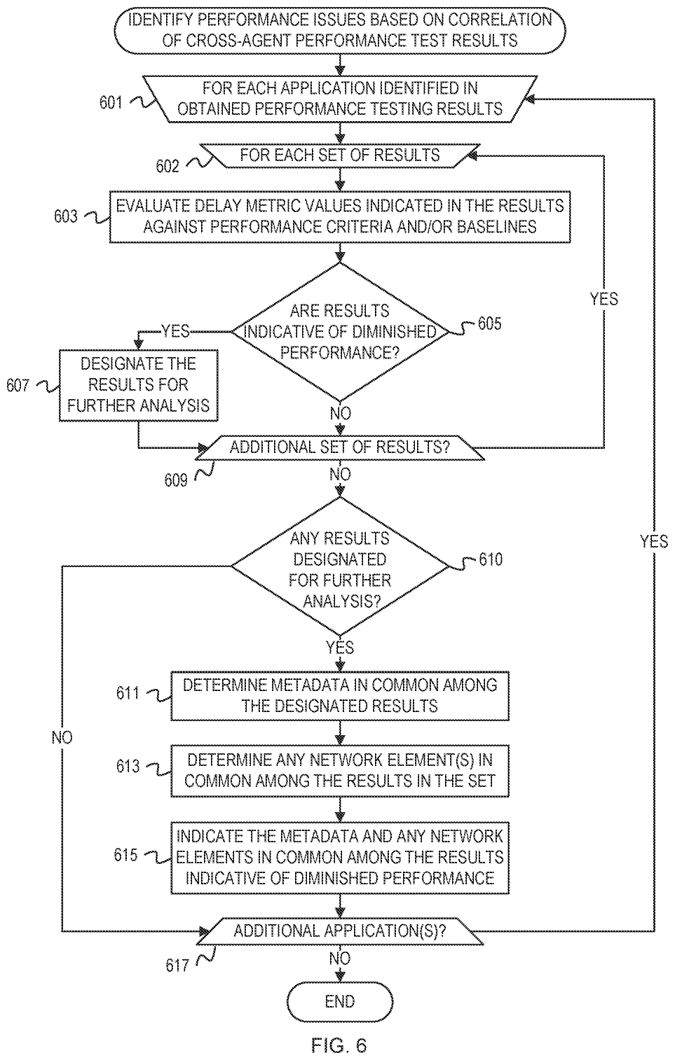

FIGS. 5-6 are flowcharts of example operations for correlation and analysis of cross-agent performance test results. The example operations are described with reference to a correlation and analysis system (hereinafter “the system”) for consistency with the earlier figures. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 5 is a flowchart of example operations for obtaining and processing cross-agent performance testing results. The example operations assume that a plurality of agents deployed to corresponding ones of a plurality of test sources have tested performance of an application and network elements traversed by network traffic of the application and generated results of the performance testing as described above.

At block 501, the system obtains a plurality of sets of performance testing results and associated metadata from deployed agents. Collection of sets of results across agents may be triggered by the system detecting results that are reported to the system by the agents (e.g., based on a schedule for result reporting enforced across agents) or by the system detecting that the current time is a scheduled time for collection of results from the agents. Though described as obtaining sets of results in bulk in this example, in other examples, collection of results by the system may be ongoing (e.g., as agents report results to the system), staggered across agents, or otherwise asynchronous across agents. Obtained sets of results may be placed in a queue(s) for processing by the system due to the volume of results.

At block 503, the system begins processing each of the obtained sets of results. The system may process each of the results that were placed in a queue(s) as described at block 501 at least partially in parallel or concurrently (e.g., by processing results in batches). Subsequent operations refer to each set of results individually for clarity and to aid in understanding, though implementations are not limited to iteration through individual sets of results for processing.

At block 505, the system determines if additional metadata are indicated for association with the results. The system may maintain additional properties, such as known properties that were obtained from other internal and/or third party systems based on known information about testing sources and stored on the system, that are to be associated with test results obtained from at least a subset of deployed agents as metadata. The additional properties may be indicated for association with each set of obtained results and/or for subsets of obtained results. For instance, a first property may specify particular metadata that should already be associated with a set of results as a condition for association of the first property therewith as additional metadata (e.g., results corresponding to a particular ISP, a particular region, etc.). If additional metadata should be associated with the results, operations continue at block 507, where the system associates the additional metadata with the results. The system may associate the additional metadata with the results by labeling, tagging, or otherwise attaching the additional property(ies) to the results. Otherwise, operations continue at block 508.

At block 508, the system updates one or more performance baselines and/or criteria for the application corresponding to the results based on delay metric values corresponding to the results. The system can maintain a performance baseline(s) and/or criteria for one or more delay metric value types that reflect average or expected values for each application. Baseline values and/or criteria may be maintained as a rolling aggregate/average that is updated as new results and corresponding delay metric values are obtained. Examples of baselines/criteria that the system can maintain include a baseline end-to-end latency for the application, a baseline jitter for the application, and/or a baseline latency(ies) for a particular request(s) or API invocation(s) issued to the application. The baseline values may have associated error thresholds that may correspond to a standard deviation of the delay metric values of the corresponding type that the system determines. To update the performance baseline/criteria for a delay metric value type, the system may aggregate (e.g., average) the delay metric values obtained for the application that correspond to one or more test types (i.e., in terms of the network tests and application tests performed and having delay metric values recorded in the results).

Block 508 is depicted with dashed lines to indicate that the corresponding operation may be performed optionally, such as during some cross-agent results collection events. Whether or not the system performs the update based on delay metric values indicated in a set of results may be based on satisfaction of a criterion. As an example, the system may perform the update for the application based on the first N sets of results that indicate the application, where N is a configurable number of results obtained from deployed agents, such that the baseline(s)/criteria are based on the first N delay metric value(s). The system may periodically “refresh” the baseline(s)/criteria at scheduled time increments to account for changes in network conditions, such as by updating the baseline/criteria each week based on delay metric values of another N sets of results. In other examples, the baseline(s)/criteria may have been previously determined and specified in a configuration of the system. For instance, at least a first baseline or criterion may have been determined for each target application based on prior analysis of historical performance data. In these examples, updating the baseline(s)/criteria may be omitted.

At block 509, the system stores the results and associated metadata with cross-agent test results. The system may maintain or have access to a repository (e.g., a repository stored on an external server) for storage of test results obtained across agents. The repository may expose an API or other query interface by which the repository can be queried by metadata with which results stored therein were labeled, tagged, etc. The system also can include an indication of a time associated with the results on insertion into the repository. The time may be a timestamp of the time at which the system received the results, a timestamp that was previously associated with the results by the agent that generated the results or a timeframe corresponding to scheduled results collection by the system (e.g., a timeframe corresponding to a 10 minute period if results are collected every 10 minutes).

At block 511, the system determines if additional results are remaining (e.g., based on whether additional results have been queued). If additional results are remaining, operations continue at block 503. Otherwise, operations are complete until additional results are obtained from agents.

FIG. 6 is a flowchart of example operations for identifying performance issues based on correlation of cross-agent performance test results. Execution of the example operations can be ongoing as performance test results are obtained from deployed agents. In the example in which test result collection is performed according to a schedule, analysis of the results as is described in the example operations also may adhere to the schedule. To illustrate, if test results are obtained from deployed agents every ten minutes, then the example operations are performed for those test results corresponding to the ten-minute period. Analysis of results may be performed as part of a results ingestion pipeline (e.g., at least partially in conjunction with the example operations of FIG. 5).

At block 601, the system begins evaluation of performance testing results corresponding to each application represented in the obtained results. Applications may be indicated (e.g., based on an application identifier) in data of the performance testing results or as metadata associated with the results. The performance test results that are considered in the evaluation may include those corresponding to a particular timeframe, such as the performance test results collected for the application during a 15 minute timeframe. The timeframe may be based on a schedule of result collection or a configurable number of result collection events (e.g., three collection events) and may be a setting of or a parameter value provided to the system. The system thus can evaluate the performance test results that corresponding to each application for the designated timeframe.

At block 602, the system begins iterating through each set of results corresponding to the application. The results can comprise an end-to-end latency of the path from the testing source from which the results originate to the application IP address, IP addresses and corresponding delay metric values of each intermediate network element on the path, and delay metric values associated with invocations of application functionality (e.g., API calls and/or requests for application resources).

At block 603, the system evaluates the delay metric values indicated in the results against one or more performance criteria and/or performance baselines. As described above in reference to FIG. 5, the system can maintain one or more performance baselines and/or criteria that reflect average or expected delay associated with each application. The system evaluates at least a first delay metric value based on the baseline/criteria to determine whether the delay metric value substantially deviates from the baseline or fails to satisfy the criteria. As an example, the system may maintain a baseline value for each of one or more delay metric value types that may also be associated with a corresponding error threshold(s), such as an error threshold corresponding to a standard deviation of values calculated for that metric value type. The system will determine that a delay metric value substantially deviates from the corresponding baseline value if the delay metric value determined for the application exceeds the baseline by greater than the amount specified by the error threshold. As another example, the criteria may indicate a threshold delay metric value of at least a first type (e.g., a threshold latency for the end-to-end latency, latency of a particular request communicated to the application, or a combination thereof). The system can evaluate the delay metric value(s) of that type(s) that is indicated in the results against the threshold(s) and, if the delay metric value exceeds the threshold(s), the delay metric value(s) is determined to fail to satisfy the criteria. If an aggregate score was determined as part of performance testing of the application as described at block 325 of FIG. 3, the system can evaluate the application's aggregate score against a criterion (e.g., a threshold or range) for application performance testing scores.

At block 605, the system determines if the results are indicative of diminished performance of the application. Diminished performance of the application may be caused by delays incurred during traversal of network elements by network traffic and/or delays incurred by the application itself. The results may be indicative of diminished performance of the application if one or more delay metric values determined from testing associated with the application (e.g., an average end-to-end latency and/or average latency of accessing a first resource of the application) exceeds a threshold specified by the performance criteria or substantially deviates from the performance baseline(s) based on which the delay metric values of the results were evaluated at block 603. If an aggregate score indicative of application delay was determined as part of application performance testing, the system can determine that the results are indicative of diminished performance if the aggregate score fails to satisfy the criterion for application performance testing scores (e.g., by exceeding a maximum score threshold if higher scores are assigned to higher delay metrics or by corresponding to a range of scores indicative of high delay). If the results are indicative of diminished application performance, operations continue at block 607. Otherwise, operations continue at block 609.

At block 607, the system designates the results for further analysis. Designating the results for further analysis may include flagging the results (e.g., through labelling or tagging). As another example, the system may add the results to a set of results that will be analyzed further. Results designated for further analysis can correspond to one or more applications.

At block 609, the system determines whether there is another set of results corresponding to the application. If there is another set of results that indicate the application remaining for delay metric value evaluation, operations continue at block 602. Otherwise, operations continue at block 610.

At block 610, the system determines if any of the results are designated for further analysis. If results are designated for further analysis, operations continue at block 611. Otherwise, if none of the obtained results were designated for further analysis, the results corresponding to the application are not indicative of diminished performance, and operations continue at block 617.

At block 611, the system determines metadata in common among the results in the set designated for further analysis. The metadata in common among the results that were determined to be indicative of diminished performance indicate the impact of the diminished performance, such as in terms of a geographic area in which end users affected by the diminished performance are located, an ISP that services the affected end users, and/or a type of technology used by the affected end users to access the application. The system may determine the intersection of the metadata across results, where the intersection comprises the metadata associated with each of the results. Alternatively, or in addition, the system may determine metadata in common among at least a designated proportion of the results, where the proportion is a configurable setting of the system and may be represented as a percentage, fraction, etc. As an example, the proportion may be configured as 85% so that the system determines metadata in common among at least 85% of the results in the set designated for further analysis. Metadata in common among a proportion of the results rather than the entirety of the results as well as the corresponding results themselves can be associated with an indication of the corresponding proportion by the system (e.g., through labeling, tagging, etc.).

At block 613, the system determines any network element(s) in common among the results in the set. Each of the results in the set includes a subset that comprises IP addresses of the intermediate network elements along the path between the respective testing source and target application. A network element identified in each of the results of the set is a common hop along the corresponding paths, and the diminished performance may thus be attributable to the network element (e.g., due to an outage or other performance issue impacting a router). The system can determine the intersection of the subsets of the results that correspond to network element IP addresses such that the intersection comprises any IP addresses of intermediate network elements in common among the results. The system may further evaluate the performance of the network element(s) in common among the results to determine whether any delay metric values indicate diminished performance of the network element(s) that is consistent across results. For instance, the system may evaluate the delay metric values collected for the network element(s) across results against at least a first performance criterion for network elements, such as a threshold for jitter or packet loss. The diminished performance may be determined to be attributable to the network element(s) if a substantial proportion of the delay metrics fail to satisfy the performance criterion, where the “substantial proportion” is a given percentage, fraction, or other threshold amount (e.g., at least 85% of delay metric values of a same type).

At block 615, the system indicates the metadata and any network elements in common among the results that are indicative of diminished performance. The system may generate a notification or report that comprises indications of the metadata and any network elements in common among the set of results that were determined to be indicative of diminished performance. Alternatively, or in addition, the system may store the indications of the metadata and any network elements (e.g., in a database) for subsequent evaluation. The metadata can be considered to describe the impact of the diminished performance that was identified. The impact of the diminished performance may be in terms of the end users of the application that are affected by or experiencing the diminished performance, such as the geographic region of affected users and/or ISP that services the affected end users. The indicated metadata and any network elements may then be leveraged to inform remediation and corrective action to address the diminished performance issues.

At block 617, the system determines whether there is another application(s) identified in the obtained performance testing results. The determination may be made based on whether any of the results obtained for the timeframe indicate an application for which the associated results have not yet been evaluated. If there is another application identified, operations continue at block 601. Otherwise, operations are complete.

### Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 303 and 325 of FIG. 3 and/or in blocks 503 to 511 of FIG. 5 can be performed in parallel or concurrently. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

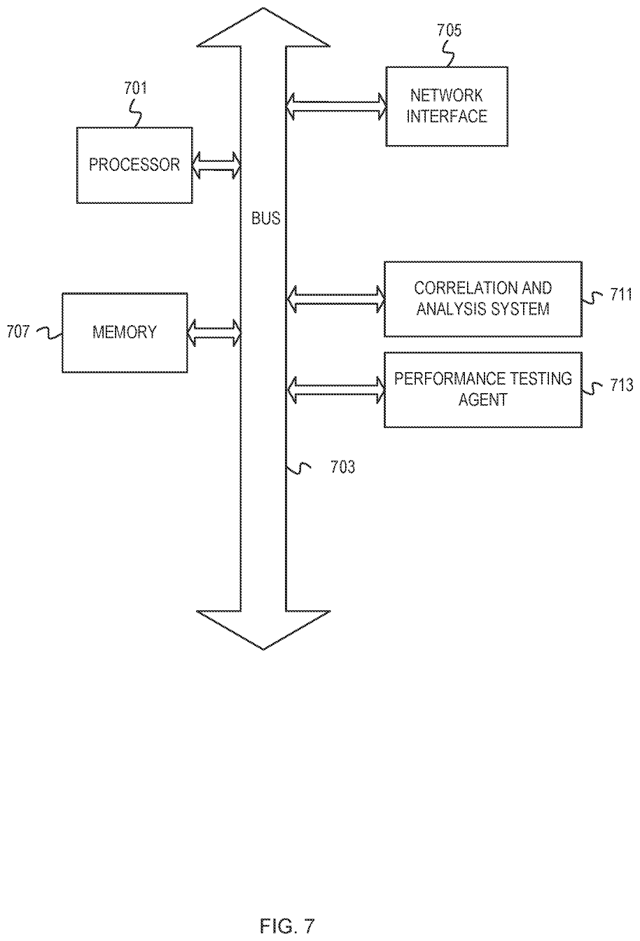

FIG. 7 depicts an example computer system with a correlation and analysis system and a performance testing agent. The computer system includes a processor 701 (possibly including multiple processors, multiple cores, multiple nodes, and/or implementing multi-threading, etc.). The computer system includes memory 707. The memory 707 may be system memory or any one or more of the above already described possible realizations of machine-readable media. The computer system also includes a bus 703 and a network interface 705. The system also includes correlation and analysis system 711 and performance testing agent 713. The correlation and analysis system 711 analyzes results of performance tests originating from different sources to identify those indicative of diminished performance of an application that may be attributable to the application itself or a network element on a path to the application and correlates those results to determine commonalities among them. The performance testing agent 713 tests performance of an application and/or network elements on a path traversed by network traffic of the application for collection of the testing results by the correlation and analysis system 711. While depicted as part of the same example computer system in FIG. 7, the correlation and analysis system 711 and performance testing agent 713 do not necessarily execute on the same system. For instance, the correlation and analysis system 711 may execute on a server, and the performance testing agent 713 may execute on an endpoint device, in a virtual machine on a different server (e.g., a cloud server), etc. Any one of the previously described functionalities may be partially (or entirely) implemented in hardware and/or on the processor 701. For example, the functionality may be implemented with an application specific integrated circuit, in logic implemented in the processor 701, in a co-processor on a peripheral device or card, etc. Further, realizations may include fewer or additional components not illustrated in FIG. 7 (e.g., video cards, audio cards, additional network interfaces, peripheral devices, etc.). The processor 701 and the network interface 705 are coupled to the bus 703. Although illustrated as being coupled to the bus 703, the memory 707 may be coupled to the processor 701.

While the aspects of the disclosure are described with reference to various implementations and exploitations, it will be understood that these aspects are illustrative and that the scope of the claims is not limited to them. In general, techniques for testing application performance and identifying causes of diminished performance based on correlation of performance testing results across testing sources as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

1. A method comprising:
obtaining a plurality of results of testing performance of an application along a plurality of paths between a plurality of testing origins to a destination Internet Protocol (IP) address of the application, wherein the plurality of results comprises metadata that are descriptive of corresponding ones of the plurality of results;
based on evaluating the plurality of results against one or more performance criteria, determining that a first subset of the plurality of results is indicative of diminished performance of the application;
determining a first characteristic in common among results of the first subset of results based on determining those of the metadata that are associated with each of the first subset of results;
determining if a subset of the plurality of paths corresponding to the first subset of results have a network element in common based on network elements indicated by the first subset of results; and
indicating impact of the diminished performance of the application, wherein indicating impact of the diminished performance comprises indicating the first characteristic and, based on determining that the subset of the plurality of paths have a first network element in common, indicating the first network element.

2. (canceled)

3. The method of claim 1, wherein each of the metadata indicate at least one of an Internet service provider (ISP) servicing a corresponding one of the plurality of testing origins, a type of technology used by the corresponding one of the plurality of testing origins, a geographic location of the corresponding one of the plurality of testing origins, and a geographic location associated with the destination IP address of the application.

4. The method of claim 1, wherein indicating impact of the diminished performance comprises indicating at least one of an ISP servicing a subset of the plurality of testing origins corresponding to the first subset of results, a geographic location of the subset of testing origins, and a type of technology used by the subset of testing origins to access the application.

5. The method of claim 1, wherein each of the plurality of results comprises delay metric values determined based on the testing, and wherein the delay metric values comprise at least one of delay metric values of a corresponding one of the plurality of paths, delay metric values of each network element along the corresponding one of the plurality of paths, and delay metric values associated with accessing one or more resources of the application.

6. The method of claim 5, wherein the delay metric values comprise at least one of latency, jitter, and packet loss.

7. The method of claim 5, wherein the performance criteria comprise one or more thresholds for a corresponding one or more types of the delay metric values, wherein evaluating the plurality of results against the one or more performance criteria comprises evaluating the delay metric values against corresponding ones of the one or more thresholds, and wherein detecting that the first subset of results is indicative of diminished performance comprises detecting that at least a first of the delay metric values indicated in the first subset of results exceeds a corresponding one of the one or more thresholds.

8. The method of claim 1 further comprising, based on determining that the subset of the plurality of paths has the first network element in common,
evaluating performance of the first network element against one or more performance criteria for network elements,
wherein indicating impact of the diminished performance of the application comprises, based on determining that the first network element fails to satisfy the one or more performance criteria, indicating that the diminished performance of the application is attributable to the first network element.

9. The method of claim 1, wherein the plurality of results of testing performance was generated by a corresponding plurality of agents, and wherein each of the plurality of agents was deployed to a corresponding one of the plurality of testing origins.

10. The method of claim 1, wherein each of the plurality of testing origins comprises an endpoint device, a cloud instance, or a wireless mobile network infrastructure element.

11. One or more non-transitory machine-readable media having program code stored thereon, the program code comprising instructions to:
evaluate a plurality of results of testing performance of an application against a first performance criterion, wherein the plurality of results corresponds to a plurality of paths between a plurality of test sources and the application and comprises a corresponding plurality of metadata that are descriptive thereof;
determine whether any of the plurality of results are indicative of diminished performance of the application based on the evaluation;
based on a determination that a first subset of the plurality of results is indicative of diminished performance of the application, determine one or more characteristics in common among results of the first subset of results based on a determination of which of the plurality of metadata are associated with each of the first subset of results;
determine whether a subset of the plurality of paths corresponding to the first subset of results have any network elements in common based on the first subset of results; and
indicate impact of the diminished performance of the application, wherein the instructions to indicate impact comprise instructions to indicate at least one of the one or more characteristics and a first network element determined to be in common among the subset of the plurality of paths.

12. The non-transitory machine-readable media of claim 11, wherein each of the plurality of metadata comprise a characteristic of at least one of a corresponding one of the plurality of test sources and the first subset of results.

13. The non-transitory machine-readable media of claim 11, wherein the instructions to evaluate the plurality of results against the first performance criterion comprise instructions to evaluate delay metric values indicated in each of the plurality of results against a threshold, and wherein the instructions to determine whether any of the plurality of results are indicative of diminished performance comprise instructions to determine whether delay metric values indicated in any of the plurality of results exceed the threshold.

14. The non-transitory machine-readable media of claim 13 further comprising instructions to:
determine one or more network elements indicated in each of the first subset of results;
evaluate delay metric values that correspond to the one or more network elements indicated in the first subset of results against a second performance criterion; and
based on a determination that at least a first delay metric value that corresponds to a first network element of the one or more network elements fails to satisfy the second performance criterion, indicate that the diminished performance of the application is attributable to the first network element.

15. An apparatus comprising:
a processor; and
a non-transitory computer-readable medium having instructions stored thereon that are executable by the processor to cause the apparatus to,
obtain a plurality of results of testing performance of an application along a plurality of paths between a corresponding plurality of testing origins to a destination Internet Protocol (IP) address of the application, wherein each of the plurality of results is associated with corresponding ones of a plurality of metadata;
evaluate the plurality of results against a first performance baseline;
determine a first subset of the plurality of results that is indicative of diminished performance of the application based on deviation from the first performance baseline;
determine a first characteristic in common among the first subset of results based on a determination of those of the plurality of metadata associated with each of the first subset of results;
determine if the first subset of results indicates network elements in common along a corresponding subset of the plurality of paths; and
indicate impact of the diminished performance of the application, wherein the indication of impact comprises indication of the first characteristic and, based on a determination that the first subset of results indicates a first network element in common, indication of the first network element.

16. (canceled)

17. The apparatus of claim 15, wherein the instructions executable by the processor to cause the apparatus to obtain the plurality of results comprise instructions executable by the processor to cause the apparatus to obtain the plurality of results from a plurality of agents deployed to a corresponding one of the plurality of testing origins, wherein each of the plurality of testing origins comprises an endpoint device, a cloud instance, or a wireless mobile network infrastructure element.

18. The apparatus of claim 15, wherein the instructions executable by the processor to cause the apparatus to evaluate the plurality of results comprise instructions executable by the processor to cause the apparatus to evaluate delay metric values indicated in the plurality of results against the first performance baseline, wherein the delay metric values comprise at least one of latencies, jitter values, and packet loss values.

19. The apparatus of claim 18, wherein the instructions executable by the processor to cause the apparatus to determine the first subset of results that is indicative of diminished performance comprise instructions executable by the processor to cause the apparatus to determine based on the evaluation that delay metric values indicated in the first subset of results deviate from the first performance baseline by a threshold amount.

20. The apparatus of claim 18 further comprising instructions executable by the processor to cause the apparatus to:
based on a determination that the first subset of results indicates a first network element in common, evaluate delay metric values that correspond to the first network element against a second performance baseline; and
wherein the instructions executable by the processor to cause the apparatus to indicate impact of the diminished performance of the application comprise instructions executable by the processor to cause the apparatus to, based on a determination that at least a first delay metric value that corresponds to the first network element fails to satisfy the second performance baseline, indicate that the diminished performance of the application is attributable to the first network element.

21. The method of claim 1, wherein determining if a subset of the plurality of paths corresponding to the first subset of results have a network element in common comprises determining an intersection of IP addresses of the network elements indicated by the first subset of results, wherein determining that the subset of the plurality of paths have the first network element in common comprises determining that the intersection of the IP addresses comprises an IP address of the first network element.

22. The method of claim 8,
wherein evaluating performance of the first network element against the one or more performance criteria for network elements comprises evaluating delay metric values corresponding to the first network element against the one or more performance criteria, wherein the delay metric values are indicated in the first subset of results,
wherein determining that the first network element fails to satisfy the one or more performance criteria comprises determining that a substantial proportion of the delay metric values corresponding to the first network element fail to satisfy at least a first of the performance criteria.
